(19) United States
(12) Patent Application Publication
(10) Pub. No.: US 2007/0220217 A1
(43) Pub. Date: Sep. 20, 2007

(54) Communication Between Virtual Machines

(76) Inventor: Udaya Shankara, Bengalooru (IN)

Correspondence Address: INTEL/BLAKELY, 1279 OAKMEAD PARKWAY, SUNNYVALE, CA, 94085-4040, US

(21) Appl. No.: 11/687,604

(22) Filed: Mar. 16, 2007

(30) Foreign Application Priority Data
Mar. 17, 2006 (IN) 1212/DEL/2006

(51) Int. Cl. G06F 13/00

(52) U.S. Cl. 711/154

(57) ABSTRACT

A computing system may comprise an accelerator that transfers the data units between a first and a second virtual machine resident on the same computing system. An abstraction block may comprise a first memory and a second memory. The abstraction block may generate a first signal in response to storing the data units in the first memory. The accelerator may transfer the data units from the first memory to the second memory in response to receiving the first signal. The accelerator may generate a second signal indicating the completion of transfer of data units from the first memory to the second memory. The abstraction block may then cause the data units to be transferred to a second virtual machine from the second memory.

This application claims priority to Indian Application Number 1212/DEL/2006 filed Mar. 17, 2006.

### BACKGROUND

A computing system generally refers to devices such as laptops, desktops, mobile phones, servers, fax machines, printers that can process data and communicate with other processing systems. The computing system may comprise one or more virtual machines each comprising independent operating systems. A virtual machine may hide the underlying hardware platform from one or more applications used by a user. As a result of hiding the underlying hardware platform, the virtual machine may allow the applications to be processed on any hardware platform.

The virtual machines resident on the computing system may communicate through the network. For example, a first virtual machine and a second virtual machine, though resident on the same computing system, may communicate with each other over a network path. However, the speed of data transfer over the network path leaves much to be desired. Moreover, because typical networks are already heavily trafficked, it is important to conserve bandwidth.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 illustrates an embodiment of a computer system 100.

FIG. 2 illustrates an embodiment of the computer system supporting one or more virtual machine that may communicate with each other.

FIG. 3 illustrates an embodiment of an operation of the computer system enabling communication between the virtual machines.

### DETAILED DESCRIPTION

The following description describes communicating between virtual machines supported by a computer system. In the following description, numerous specific details such as logic implementations, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits, and full software instruction sequences have not been shown in detail in order not to obscure the invention. Those of ordinary skill in the art, with the included descriptions, will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

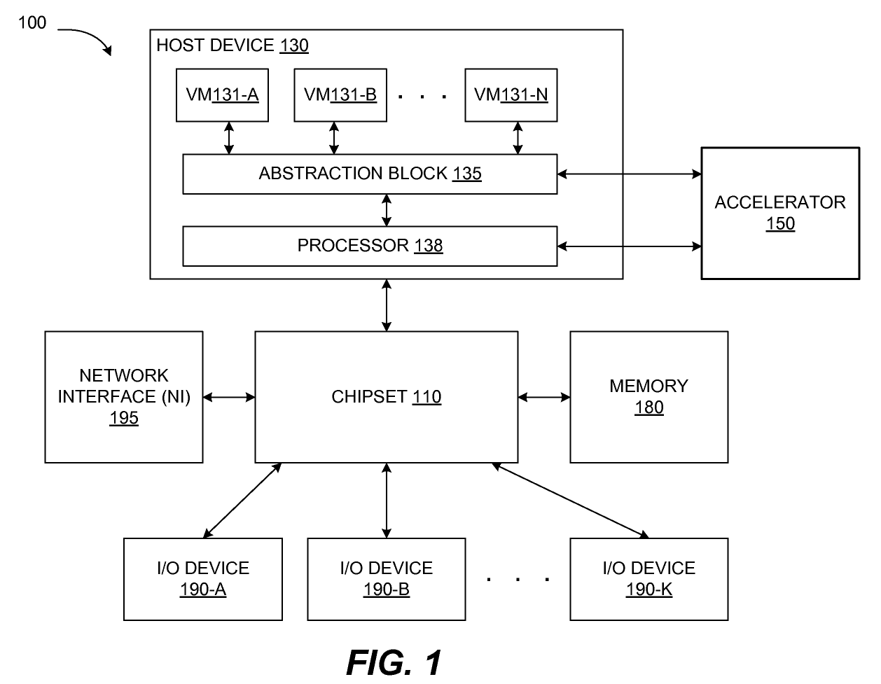

An embodiment of a computer system 100 is illustrated in FIG. 1. The computer system 100 may comprise a chipset 110, a host device 130, an accelerator 150, a memory 180, and I/O devices 190-A to 190-K.

The chipset 110 may comprise one or more integrated circuits or chips that couple the host device 130, the memory 180, and the I/O devices 190. In one embodiment, the chipset 110 may comprise controller hubs such as a memory controller hub and an I/O controller hub to, respectively, couple with the memory 180 and the I/O devices 190. The chipset 110 may receive data packets or units corresponding to a transaction generated by the I/O devices 190 and may forward the packets to the memory 180 and/or the host device 130. Also, the chipset 110 may generate and transmit data units to the memory 180 and the I/O devices 190 on behalf of the host device 130.

The memory 180 may store data and/or software instructions that the host device 130 or any other device of the computer system 100 may access and perform operations. The memory 180 may comprise one or more different types of memory devices such as, for example, DRAM (Dynamic Random Access Memory) devices, SDRAM (Synchronous DRAM) devices, DDR (Double Data Rate) SDRAM devices, or other volatile and/or non-volatile memory devices used in computer system 100.

The host device 130 may comprise one or more virtual machines 131-A to 131-N, an abstraction block 135, and a processor 138. The processor 138 may manage various resources and processes within the host device 130 and may execute software instructions as well. The processor 138 may interface with the chipset 110 to transfer data to the memory 180 and the I/O devices 190. However, the processor 138 may delegate some tasks to the accelerator 150. In one embodiment, the processor 138 may represent Pentium®, Itanium®, Dual core processor, or XScale™ family of Intel® microprocessors. In one embodiment, the processor 138 may support the abstraction block 135, which may support one or more virtual machines (VM) 131-A to 131-N.

In one embodiment, a virtual machine may comprise software that mimics the performance of a hardware device. In one embodiment, the processor 138 may perform processing of data units generated by the virtual machines 131-A to 131-N. However, the virtual machine 131-A may not be aware that the processor 138 is, also, processing the data units generated by, for example, the virtual machine 131-B. In one embodiment, the virtual machines 131-A to 131-N may be designed to operate on any underlying hardware platform such as the processor 138. As a result, the virtual machines 131-A to 131-N may operate independent of the underlying hardware platform.

In one embodiment, the host device 130 may include the abstraction block 135 such as a virtual machine monitor (VMM) that may hide the processor 138 from the virtual machines 131-A to 131-N. In one embodiment, the abstraction block 135 may hide the processor 138 from the VMs 131, which may operate on various hardware platforms such as the processor 138. Thus, the abstraction block 135 may enable any application written for the virtual machines 131 to be operated on any of the hardware platform. Such an approach may avoid creating separate versions of the applications for each hardware platform. In one embodiment, the abstraction block 135 may support one or more of same or different type of operating systems such as Windows®2000, Windows®XP, Linux, MacOS®, and UNIX® operating systems. Each operating system may support one or more applications.

The accelerator 150 may perform tasks that may be delegated by the processor 138. In one embodiment, the accelerator 150 may comprise one or more programmable processing units (PPUs) that may enable the virtual machines 131-A to 131-N to communicate with each other over virtual interfaces supported by the abstraction block 135. In one embodiment, the accelerator 150 may enable the data units to be transferred from the VM 131-A to the VM 131-B within the computer system 100. In other words, the data units generated by the VM 131-A may not use the network path supported by devices such as a physical network interface 195. In one embodiment, the accelerator 150 may support communication between the virtual machines 131 resident on the host device 130 without consuming resources of the processor 138.

In one embodiment, the accelerator 150 may comprise one or more programmable processing units (PPU). Each programmable processing unit may comprise one or more micro-programmable units (MPU). In one embodiment, the PPUs may transfer data from one virtual machine to the other virtual machine. In one embodiment, the accelerator 150 may comprise Intel® Microengine Architecture, which may comprise one or more PPUs such as microengines and each microengine may comprise N number of MPUs such as the threads.

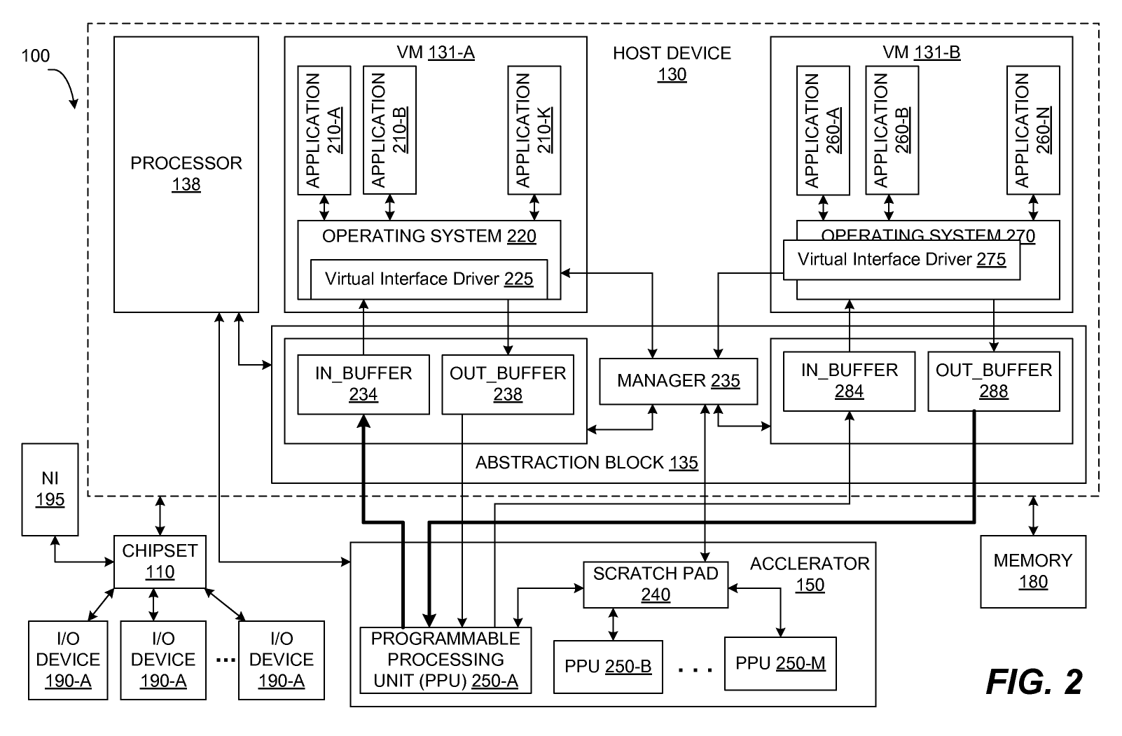

An embodiment of the computer system 100 supporting one or more virtual machines that may communicate with each other is illustrated in FIG. 2.

The virtual machine 131-A may comprise one or more applications 210-A to 210-K and an operating system 220. The virtual machine 131-B may comprise one or more applications 260-A to 260-N and an operating systems 270. The abstraction block 135 may comprise buffers such as in_buffers 234 and 284 and out_buffers 238 and 288 and a manager 235. The accelerator 150 may comprise programmable processing units 250-A to 250-M and a scratch pad 240.

In one embodiment, the applications 210-A to 210-K may be supported by the OS 220, which may be supported by the abstraction block 135. In one embodiment, the application 210-A may represent a file transfer application and the operating system 220 may comprise a Linux OS. In one embodiment, the combination of the applications 210-A to 210-K and the operating system 220 that are unaware of the processor 138 may be referred to as the virtual machine VM 131-A. The virtual machine 131-A may be associated with an address such as the IP address, for example, VM-1.

The applications 260-A to 260-N may be supported by the OS 270, which in turn may be supported by the abstraction block 135. For example, the application 260-A may represent an encryption application capable of encrypting the data units received from the operating system 270. In one embodiment, the operating system 270 may comprise a Windows® XP operating system. The combination of the applications 260-A to 260-N and the operating system 270 that are unaware of the processor 138 may be referred to as the virtual machine 131-B. The virtual machine 131-B may be assigned an address such as the IP address, for example, VM-2. The tasks generated by an operating system (OS) may be performed by the processor 138.

In one embodiment, the virtual machine 131-A may communicate with the virtual machine 131-B using the PPUs 250-A to 250-M and the scratch pad 240 of the accelerator 150. In one embodiment, the virtual machines 131, resident on the host device 130, may avoid using an external network path supported by the network interface 195 while transferring the data units to any virtual machine resident on the host device 130. For example, if an external network path is used, the virtual machines 131-A and 131-B, though resident on the same computer system 100 may communicate as being resident on two different computer systems A and B. A data unit generated by the virtual machine 131-A may, for example, traverse a path X comprising the abstraction block 135, the processor 138, the chipset 110, port-A of the network interface 195, an external network path, a port-B of the network interface 195, the chipset 110, the processor 138, and the abstraction 135 before reaching the virtual machine 131-B. As a result, the data unit may traverse a path X, which is longer as compared to a path Y comprising the abstraction block 135, the accelerator 150, and the abstraction block 135. Transferring the data units over the path Y may increase the speed of data transfer between the virtual machines 131 resident on the same computer system 100, conserve the bandwidth of the external network path, save resources of the processor 138, and reduce the traffic on the internal busses of the computer system 100.

In one embodiment, the virtual machine 131-A and 131-B may communicate with the abstraction block 135 using a virtual interface. In one embodiment, a virtual interface driver 225 supported by the operating system 220 may use application program interfaces (API) supported by the abstraction block 135 to write the data units into a corresponding buffers of the abstraction block 135. For example, the virtual interface driver 225 of the OS 220 may write data units generated by the virtual machine 131-A into the out_buffer 238.

A virtual machine interface driver 275 of the OS 270 may read the data units from the in_buffer 284, which may store the data units transferred from the out_buffer 238. In one embodiment, the virtual machine interface driver 275 may read the data units from the in_buffer 284 after receiving a ready_to_read signal from the abstraction block 135. In one embodiment, the virtual interface driver 225 and 275 may write the data units, respectively, into the out_buffers 238 and 288 and may also, respectively, read data units from the in_buffers 234 and 284.

In one embodiment, the virtual machines 131-A and 131-B may be identified, respectively, by the IP addresses VM-1 and VM-2 that may, uniquely, identify the virtual machine 131-A and 131-B supported by the host device 130. In one embodiment, the virtual machine 131-A may communicate with a virtual machine resident on other computer system using the physical network interface 195 coupled to the chipset 110.

The abstraction block 135 may comprise a manager 235 and one or more set of buffers bufferset-xy. In one embodiment, ‘x’ represents an identifier of a transmitting virtual machine and ‘y’ represents an identifier of a receiving virtual machine. In one embodiment, the abstraction block 135 may comprise a bufferset-12 and bufferset-21. The bufferset-12 may comprise the in_buffer 234 and the out_buffer 238. The in_buffer 234 may store incoming data units received from the virtual machine 131-B and that may be sent to the virtual machine 131-A. The out_buffer 238 may store outgoing data units that the virtual machine 131-A may send out to the virtual machine 131-B. Also, the abstraction block 135 may comprise a bufferset-21. In one embodiment, the bufferset-21 may comprise the in_buffer 284 to store incoming data units that the virtual machine 131-B may receive from the virtual machine 131-A and the out_buffer 288 to store outgoing data units that the virtual machine 131-B may send out to the virtual machine 131-A.

In one embodiment, the manager 235 may interface with the bufferset_12 and the bufferset-21 to determine the status of the in_buffer 234, the out_buffer 238, the in_buffer 284, and the out_buffer 288. In one embodiment, the manager 235 may determine the status by reading signals sent by the buffers based on the amount of the data units stored in the buffers. For example, the out_buffer 238 may set a half-full flag or a full-full flag, respectively, to indicate that the out_buffer 238 is storing the data units that represent half capacity and full capacity of the out_buffer 238. The manager 235 may read such status signals to determine the status of the buffers.

In one embodiment, the manager 235, while sending out data units from the virtual machine 131-A to 131-B, may store a first signal or a valid signal in a first location of the scratch pad 240 that corresponds to, for example, the PPU 250-A. In one embodiment, the first signal may indicate that the out_buffer 238 comprises data units that may be transferred to the in_buffer 284 of the destination virtual machine 131-B. In one embodiment, the first signal may comprise fields such as a validity bit, a source_buffer_num, a destination_buffer_num, a source_buffer_add, a destination_buffer_add, and a first value indicating the amount or length of data that may be transferred. In one embodiment, the manager 235 may set the validity bit to one to indicate that the out-buffer 238 of the virtual machine 131-A may comprise data units and the data units may be transferred to the in_buffer 284 of the virtual machine 131-B. In one embodiment, the manager 235 may configure the contents of the source_buffer_num field and the destination_buffer_num field to, respectively, comprise the identifiers of the out_buffer 238 and the in_buffer 284.

In one embodiment, the manager 235 may configure the contents of the source_buffer_add and the destination_buffer_add that may, respectively, indicate a start address of the memory location in the out_buffer 238 from which the data units may be read and a start address of the memory location in the in_buffer 284 from which the data units may be stored. The manager 235 may configure a length field with the first value to indicate the number of bytes or amount of the data units that may be read starting from the start address stored in the source_buffer_add.

In one embodiment, the manager 235 may poll the first location of the scratch pad 240 at a pre-determined frequency. In one embodiment, the manager 235 may check for a change in the status of the validity bit of the valid signal stored in the first location in the scratch pad 240. In one embodiment, the manger 235 may generate a third signal representing, for example, a ready_to_read signal after determining that the status of the validity bit of the first signal stored in the first location of the scratch pad 240 is changed, for example, to zero. A zero stored in the validity bit may indicate the availability of the data units in the in_buffer 284. In one embodiment, zero in the validity bit may indicate that the transfer of the data units from the out_buffer 238 to the in_buffer 284 is complete and the virtual machine 131-B may read the data units. In one embodiment, the manager 235 may send the ready_to_read signal to the virtual machine driver 275 of the operating system 270. In one embodiment, the virtual machine 131-B may read the data units from the in_buffer 284 after receiving the third signal. In other embodiments, the manager 235 may cause the data units, stored in the in_buffer 284, to be transferred to the virtual machine 131-B.

The accelerator 150 may comprise a scratch pad 240 and one or more programmable processing units (PPU) 250-A to 250-M. Each PPU may comprise one or more micro-programmable units (MPUs). In one embodiment the accelerator 150 may comprise Intel® IXA Architecture. In one embodiment, the PPU 250-A may poll the first location of the scratch pad 240 at a pre-determined frequency to determine if the first signal or a valid signal is present. If the first signal is present, the PPU 250-A may transfer, starting from the start address source_buffer_add, the data units equaling the first value from the source buffer, the out_buffer 238, to the destination buffer, the in_buffer 284. In one embodiment, PPU 250-A may generate a second signal, for example, by resetting or setting to zero the validity bit of the first signal after the data units stored in the out_buffer 238 are transferred to the in_buffer 284. In one embodiment, the generation of the second signal by the PPU 250-A may indicate the completion of transfer of data units from the out_buffer 238 to the in_buffer 284. Thus, the virtual machine 131-A may transfer the data units to the virtual machine 131-B over the virtual interface thus avoiding the path X comprising the processor 138.

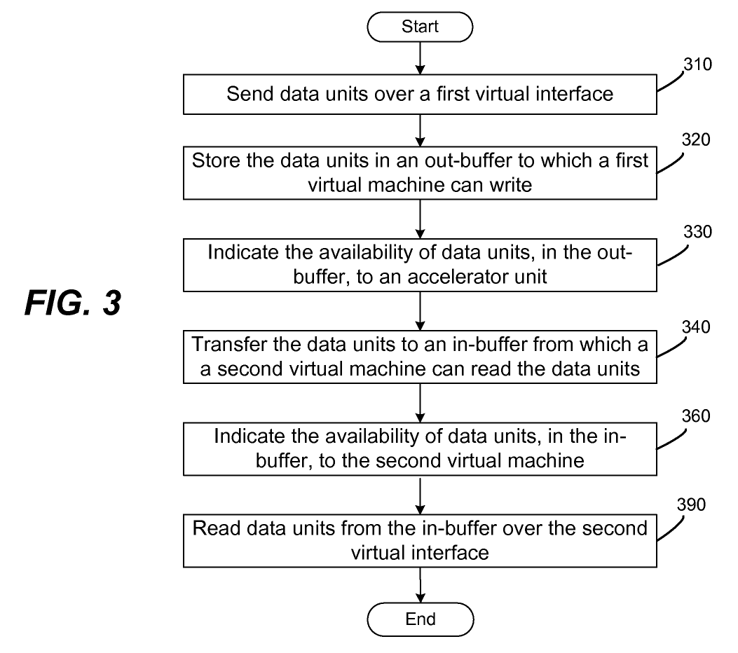

An embodiment of an operation of the computer system 100 supporting communication of data units between two virtual machines supported on the computer system 100 is illustrated in FIG. 3. In block 310, the virtual machine 131-A may send data units over a first virtual interface. In one embodiment, the first virtual interface may be provisioned between the abstraction block 135 and the OS 220. In one embodiment, the OS 220 may cause the virtual interface driver 225 to send the data units to the out_buffer 238.

In block 320, the abstraction block 135 may store the data units in the out_buffer 238, which can be accessed by the virtual machine 131-A. In one embodiment, the virtual interface 235 may write the data units into the out_buffer 238 using the APIs supported by the abstraction block 135.

In block 330, the abstraction block 135 may indicate the availability of data units, in the out_buffer 238, to the programmable processing unit such as the PPU 250-A of the accelerator 150. In one embodiment, the manager 235 of the abstraction 135 may store a valid signal comprising fields such as the validity bit, identifier of the out_buffer 238 and the in_buffer 284, and address of the memory location within the buffers from which data may be read and stored, and the length indicating the number of bytes that may be transferred. In one embodiment, the manager 235 may set the validity bit equal to one and the identifier of the out-buffer to equal the identifier of the out_buffer 238

In block 340, the programmable processing unit (PPU) may transfer the data units to the in_buffer 284 from which the virtual machine 131-B may read the data units. In one embodiment, the PPU 250-A may transfer the data units from the out_buffer 238 of the virtual machine 131-A to the in_buffer 284 of the virtual machine 131-B. In one embodiment, the MPUs of the PPU may read the data units stored in the out_buffer 238 and store the data units into the in_buffer 284. The PPU 250-A may reset the validity bit of the valid signal stored in the first location to indicate to that the transfer of the data units is complete.

In block 360, the abstraction block 135 may inform the availability of data units in the in_buffer 284 of the virtual machine 131-B by sending, for example, a ready_to_read signal.

In block 390, the virtual machine 131-B may read the data units received from the virtual machine—131-A over a second virtual interface. In one embodiment, the second virtual interface may be provisioned between the abstraction block 135 and the OS 270.

Certain features of the invention have been described with reference to example embodiments. However, the description is not intended to be construed in a limiting sense. Various modifications of the example embodiments, as well as other embodiments of the invention, which are apparent to persons skilled in the art to which the invention pertains are deemed to lie within the spirit and scope of the invention.

What is claimed is:

1. An apparatus comprising:
an abstraction block having a first memory and a second memory;
a first virtual machine coupled to the abstraction block, wherein the first virtual machine is to transfer data units to the first memory;
a second virtual machine coupled to the abstraction block, wherein the second virtual machine is to transfer the data units from the second memory; and
an accelerator unit coupled to the abstraction block, wherein the accelerator unit is to detect that the data units have been transferred to the first memory and transfer the data units from the first memory to the second memory.

2. The apparatus of claim 1, wherein the abstraction block comprises
a manager to generate a first signal indicating the availability of the data units in the first memory, and
the manager to store the first signal in a scratch pad, and
wherein the first memory to store the data units received from the first virtual machine over a first virtual interface.

3. The apparatus of claim 1, wherein
the manager to poll the scratch pad at a pre-determined frequency,
the manager to generate a third signal in response to accessing a second signal from the scratch pad, and
the second virtual machine to transfer the data units stored in the second memory over the second virtual interface, and
wherein the second memory to store the data units that are to be transferred to the second virtual machine over a second virtual interface.

4. The apparatus of claim 2, wherein the first signal comprises a first identifier to indicate the first memory as a source and a second identifier to indicate the second memory as a destination.

5. The apparatus of claim 2, wherein the first signal comprises a start address of the first memory from which the data units is to be transferred to the second memory and a first value to indicate the amount of data to be transferred to the second memory.

6. The apparatus of claim 2, wherein the accelerator unit further comprises
a scratch pad to store the first signal,
a programmable processing unit to poll the scratch pad at a pre-determined frequency, and
the programmable processing unit to transfer the data units from the first memory to the second memory in response to accessing the first signal from the scratch pad.

7. The apparatus of claim 6, wherein the accelerator unit comprises
the programmable processing unit to generate the second signal to indicate the completion of transfer of data units from the first memory to the second memory, and
the programmable processing unit to store the second signal in the scratch pad.

8. A method to transfer data units from a first virtual machine to a second virtual machine, comprising:
transferring the data units from the first virtual machine to a first memory;
detecting that the data units have been transferred to the first memory;
transferring the data units from the first memory to a second memory through an acceleration unit;
detecting that the data units have been transferred to the second memory; and
transferring the data units from the second memory to the second virtual machine.

9. The method of claim 8, wherein transferring the data units from the first virtual machine to the first memory comprise
storing the data units received from the first virtual machine over a first virtual interface in the first memory,
generating a first signal indicating the availability of the data units in the first memory, and
storing the first signal in a scratch pad.

10. The method of claim 9, wherein generating the first signal further comprises
including a first identifier to indicate the first memory as a source and a second identifier to indicate the second memory as a destination, and
including a start address of the first memory from which the data units is to be transferred to the second memory and a first value to indicate the amount of data to be transferred to the second memory.

11. The method of claim 8, wherein detecting if the data units have been transferred to the first memory comprise
polling the scratch pad at a pre-determined frequency, and
accessing the first signal from the scratch pad, and
wherein the availability of the first signal in the scratch pad indicates the availability of the data units in the first memory.

12. The method of claim 8, wherein transferring the data units from the first memory to a second memory through an acceleration unit comprise
retrieving the data units from the first memory starting from the start address,
storing the data units in the second memory, wherein the quantity of the data units stored in the second memory is based on the first value,
generating a second signal indicating the availability of the data units in the second memory and storing the second signal in the scratch pad.

13. The method of claim 8, wherein detecting if the data units have been transferred to the second memory comprise
polling the scratch pad at a pre-determined frequency, and
accessing the second signal from the scratch pad, and
wherein the availability of the second signal in the scratch pad indicates the availability of the data units in the second memory.

14. The method of claim 8, wherein transferring the data units from the second memory to the second virtual machine comprise
generating a third signal in response to accessing the second signal from the scratch pad, and
transferring the data units from the second memory to the second virtual machine over the second virtual interface.

15. A machine readable medium comprising a plurality of instructions that in response to being executed result in a computing device
transferring the data units from the first virtual machine to a first memory;
detecting that the data units have been transferred to the first memory;
transferring the data units from the first memory to a second memory through an acceleration unit;
detecting that the data units have been transferred to the second memory; and
transferring the data units from the second memory to the second virtual machine.

16. The machine readable medium of claim 15, wherein transferring the data units from the first virtual machine to the first memory comprise
storing the data units received from the first virtual machine over a first virtual interface in the first memory,
generating a first signal indicating the availability of the data units in the first memory, and
storing the first signal in a scratch pad.

17. The machine readable medium of claim 16, wherein generating the first signal further comprises
including a first identifier to indicate the first memory as a source and a second identifier to indicate the second memory as a destination, and
including a start address of the first memory from which the data units is to be transferred to the second memory and a first value to indicate the amount of data to be transferred to the second memory.

18. The machine readable medium of claim 15, wherein detecting if the data units have been transferred to the first memory comprise
polling the scratch pad at a pre-determined frequency, and
accessing the first signal from the scratch pad, and
wherein the availability of the first signal in the scratch pad indicates the availability of the data units in the first memory.

19. The machine readable medium of claim 15, wherein transferring the data units from the first memory to a second memory through an acceleration unit comprise
retrieving the data units from the first memory starting from the start address,
storing the data units in the second memory, wherein the quantity of the data units stored in the second memory is based on the first value,
generating a second signal indicating the availability of the data units in the second memory and storing the second signal in the scratch pad.

20. The machine readable medium of claim 15, wherein detecting if the data units have been transferred to the second memory comprise
polling the scratch pad at a pre-determined frequency, and
accessing the second signal from the scratch pad, and
wherein the availability of the second signal in the scratch pad indicates the availability of the data units in the second memory.

21. The machine readable medium of claim 15, wherein transferring the data units from the second memory to the second virtual machine comprise
generating a third signal in response to accessing the second signal from the scratch pad, and
transferring the data units from the second memory to the second virtual machine over the second virtual interface.
